(19) United States
(12) Patent Application Publication
(10) Pub. No.: US 2013/0027348 A1
(43) Pub. Date: Jan. 31, 2013

(54) TOUCH SENSING PANEL AND DEVICE FOR DETECTING MULTI-TOUCH SIGNAL

(71) Applicants: Do Hwan Oh, Seoul (KR); Byung Sang Rhim, Seoul (KR)

(72) Inventors: Do Hwan Oh, Seoul (KR); Byung Sang Rhim, Seoul (KR)

(73) Assignee: MELFAS, INC., Seoul (KR)

(21) Appl. No.: 13/639,787

(22) PCT Filed: Feb. 25, 2011
(86) PCT No.: PCT/KR2011/001351

§ 371 Date: Oct. 5, 2012

(30) Foreign Application Priority Data
Apr. 8, 2010 (KR) 10-2010-0032348

(51) Int. Cl. G06F 3/044; G06F 3/041

(52) U.S. Cl. 345/174; 345/173

(57) ABSTRACT

Provided are a touch sensing panel and a touch sensing apparatus for detecting an absolute location with respect to at least one touch, including a driving electrode forming a mutual capacitance between a sensing electrode and the driving electrode in response to a predetermined driving signal and including at least two electrode surfaces divided by a width size.

### TECHNICAL FIELD

The present invention relates to a touch sensing technology for detecting a touch, and more particularly, to a touch sensing panel and a touch sensing apparatus for detecting an absolute location with respect to at least one touch.

### BACKGROUND ART

A touch sensing technology for detecting a touch by a finger of a user or by an apparatus, and for converting the touch to a suitable electric signal and outputting the electric signal has been applied to various electric devices to be used as various input means.

The touch sensing technology may be applied to a laptop computer to be used as a means of controlling a move of a curser replacing a mouse. The touch sensing technology may be combined with a display device to be used as an input means capable of directly selecting and executing an icon or a menu displayed on a screen.

Recently, a screen of an electric device is being maximized and the electric device is being miniaturized and thus, an input device such as a keypad may be excluded, and a case of using a touch screen combined with a display as an only input means is on the rise.

The expansion of applying the touch sensing apparatus may involve a change of an input scheme, and one example may correspond to a scheme of detecting at least two touched inputs.

An existing touch sensing apparatus has been detecting a single touched input, and an input type has been limited.

For example, in the touch sensing technology replacing a mouse, even though a location of a curser is controlled by a touched input, an input corresponding to a click has been performed by an additional button. However, a recent touch sensing technology may recognize at least two touched inputs without an additional button.

To recognize at least two touched inputs, relative motions of the at least two touched inputs may be detected, or absolute coordinates of the at least two touched inputs may be independently detected.

Even though a function of detecting relative motions may be implemented by various Indium Tin Oxide (ITO) electrode patterns such as 1-layer, 2-layer (diamond pattern), and the like, a ghost phenomenon where an absolute coordinate of a plurality of touched inputs may not be calculated may occur.

Recently, to overcome the ghost phenomenon, a number of manufacturers tend to apply a drive-sensing principle where absolute coordinates of a plurality of touched inputs are calculated.

### DISCLOSURE OF INVENTION

### Technical Problem

According to an aspect of the present invention, by enhancing a sensitivity of a mutual capacitance detected based on a drive-sensing principle, a touch sensitivity may consequentially be enhanced.

According to an aspect of the present invention, by forming an additional electrode grounded between driving electrodes at a bottom side, noise occurring from a liquid crystal display (LCD) may be consistently shielded.

According to an aspect of the present invention, by reducing an area where a sensing electrode intersects a driving electrode, a transparency of a touch sensing panel may be enhanced.

### Solution to Problem

According to an aspect of the present invention, there is provided a touch sensing panel, including a plurality of first electrodes, and a plurality of second electrodes to which a driving signal is applied, wherein the plurality of first electrodes are electrically insulated from the plurality of second electrodes, and each of the plurality of second electrodes is placed at a location corresponding to the plurality of first electrodes, and has a relatively narrow width.

According to another aspect of the present invention, there is provided a touch sensing apparatus, including a plurality of first electrodes extending in a first axial direction, a plurality of second electrodes extending in a second axial direction intersecting with the first axial direction, and a controller chip to determine a touched input based on a detected signal generated between the plurality of first electrodes and the plurality of second electrodes, wherein each of the plurality of second electrodes has a variable width along the second axial direction, and each width of the plurality of second electrodes has a minimal value at a point where the plurality of second electrodes intersect the plurality of first electrodes.

### BRIEF DESCRIPTION OF DRAWINGS

FIG. 1 is a diagram illustrating a side view of a touch sensing panel according to an embodiment of the present invention.

FIG. 2 is a diagram illustrating a first electrode according to an embodiment of the present invention.

FIG. 3 is a diagram illustrating a second electrode according to an embodiment of the present invention.

FIG. 4 is a diagram illustrating a first electrode and a second electrode overlapped with each other according to an embodiment of the present invention.

FIG. 5 is a diagram illustrating a third electrode and a second electrode according to another embodiment of the present invention.

FIG. 6 is a flowchart illustrating a manufacturing scheme of a touch sensing panel according to an embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

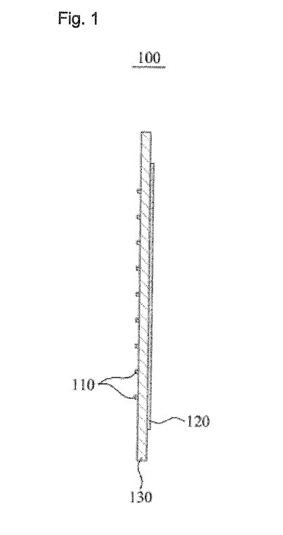

FIG. 1 is a diagram illustrating a side view of a touch sensing panel 100 according to an embodiment of the present invention.

The touch sensing panel 100 according to an embodiment of the present invention may include a plurality of first electrodes 110 and a plurality of second electrodes 120.

A driving signal may be applied to each of the plurality of second electrodes 120, and the plurality of first electrodes 110 may be electrically insulated from the plurality of second electrodes 120. Each of the plurality of second electrodes 120 may have a relatively narrow width at a location corresponding to the plurality of first electrodes 110.

The plurality of first electrodes 110 and the plurality of second electrodes 120 according to an embodiment of the present invention may be placed on an extension line of each axial direction, and may intersect with each other. In this instance, intersecting points of each of the plurality of first electrodes 110 and the plurality of second electrodes 120 may be disposed in a matrix form on a two-dimensional (2D) plane.

The touch sensing panel 100 according to an embodiment of the present invention may electrically insulate the first electrodes 110 from the second electrodes 120 through a transparent substrate 130.

At least one of the plurality of first electrodes 110 and the plurality of second electrodes 120 may be regarded as an Indium Tin Oxide (ITO) on a glass substrate.

In a case where the touch sensing panel 100 may not be transparent and is used as only a means for an input, the at least one of the first electrodes 110 and the second electrodes 120 may be regarded as copper on a flame retardant 4 (FR4) material.

The first electrodes 110 may be regarded as a sensing electrode for detecting multiple touches by a driving-sensing principle. In this instance, the second electrodes 120 may be regarded as a driving electrode where a driving signal is applied.

In particular, at least one of the plurality of first electrodes 110 and the plurality of second electrodes 120 may include a plurality of electrode patterns.

The second electrodes 120 may be formed by a plurality of electrode patterns, and a driving signal may be successively applied to each of the electrode patterns.

In this instance, electrode patterns where a driving signal is applied may be determined to be activated, and electrode patterns where a driving signal is not applied may be determined to be inactive.

In response to a touch, a change of a mutual capacitance in response to an activation of the second electrodes 120 may be detected in a portion of electrode patterns among a plurality of electrode patterns of the first electrodes 110.

A change of a mutual capacitance with respect to an area where a touch occurs on an intersecting point of the second electrodes 120 and the activated first electrodes 110 may be detected.

The touch sensing panel 100 according to an embodiment of the present invention may determine an absolute location with respect to an area where at least one touch occurs.

The touch sensing panel 100 according to an embodiment of the present invention may be used for a touch screen apparatus having a display apparatus for displaying a user interface, and a circuit for generating a control signal controlling a host device by recognizing a touch event occurring at different locations on a touch sensitive surface.

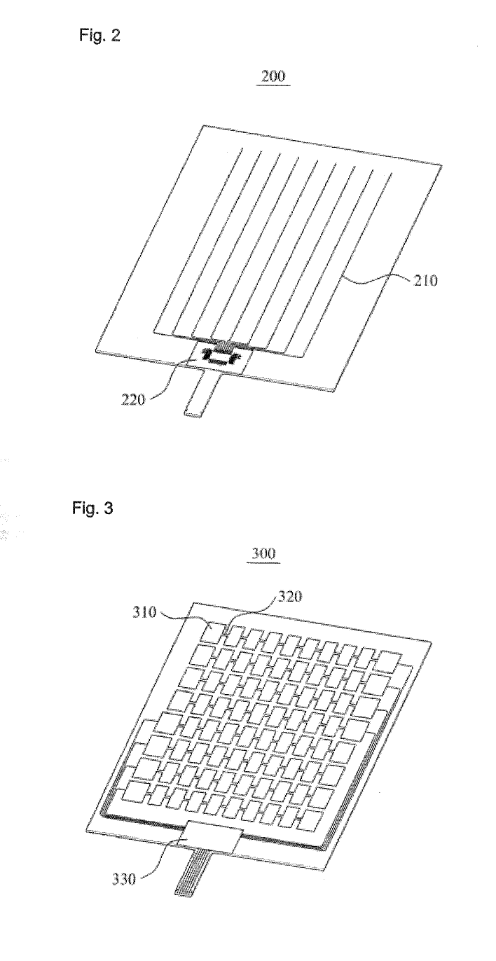

FIG. 2 is a diagram illustrating a first electrode 200 according to an embodiment of the present invention.

The first electrode 200 may be formed at one side of a touch sensing panel 200.

The first electrode 200 may be regarded as a sensing electrode for a sensing in a driving-sensing principle.

The first electrode 200 may be formed in a form of including a plurality of lines 210, and each of the plurality of lines 210 may be connected to a touch sensor chip 220. The touch sensor chip 220 may determine a location where a detected signal is received among the plurality of lines 210 and may output a selected control signal controlling a display device.

The detected signal generated in the first electrode 200 may be generated by a change of a mutual capacitance occurring between a second electrode and the first electrode 200.

The first electrode 200 according to an embodiment of the present invention may be formed in a first axial direction.

FIG. 3 is a diagram illustrating a second electrode 300 according to an embodiment of the present invention.

The second electrode 300 may include a plurality of electrode patterns, and the plurality of electrode patterns may be formed on an extension line in a second axial direction.

The first electrode 200 may be electrically insulated from the second electrode 300, and each electrode pattern configuring the second electrode 300 may have a relatively narrow width at a location corresponding to the first electrode 200.

The second axial direction according to an embodiment of the present invention may intersect the first axial direction of the first electrode. For example, the first axial direction may be orthogonal to the second axial direction.

The plurality of electrode patterns configuring the second electrode 300 according to an embodiment of the present invention may include at least two electrode surfaces divided by a width size.

As a particular example, the plurality of electrode patterns configuring the second electrode 300 according to an embodiment of the present invention may include two electrode surfaces 310 and 320 divided by two different widths. Hereinafter, the two electrode surfaces 310 and 320 may be referred to as a first electrode surface 310 and a second electrode surface 320.

First, the plurality of electrode patterns configuring the second electrode 300 may be formed in a form where the first electrode surface 310 having a relatively wide width and the second electrode surface 320 having a relatively narrow width are repeated.

The first electrode surface 310 and the second electrode surface 320 may be electrically shorted, and may be formed by a scheme of etching a part of a surface from an electrode having the same material considering a resistance.

For convenience of description, to divide the first electrode surface 310 and the second electrode surface 320, a width unit may be used. Depending on viewpoints, a height or an area may be used instead of the width. However, the width unit may be used based on the first axial direction of the first electrode.

The width size may be measured in the first axial direction of the first electrode. The width size may be regarded as a scalar value measured in the first axial direction.

In this description, a form where the electrode patterns configuring the second electrode 300 corresponding to a driving electrode are configured by electrode surfaces having two different widths has been described. However, it may be clear that the form may be changed to have at least three electrode surfaces.

Each electrode pattern configuring the second electrode 300 may be connected to a touch sensor chip 330 through a wiring.

The touch sensor chip 330 may generate a driving signal to perform an operation of sequentially transmitting the driving signal to each electrode pattern configuring the second electrode 300.

The touch sensor chip 330 according to an embodiment of the present invention may correct errors of the detected signal due to a resistance component present between two ends of the first electrode and the second electrode with reference to a predetermined correcting table, and may generate the touch information.

The first electrode corresponding to a sensing electrode may be formed to extend in the first axial direction and thus, an error due to a resistance component may occur while determining a touch. Accordingly, the touch sensor chip 330 may include a compensation logic for compensating for a calculated touch coordinate or a touched signal generated in a plurality of electrode patterns configuring the first electrode. As a particular example, a predetermined table may be included to be referred to for a compensation.

In this instance, the table may be stored in a separate memory, and may be called to be used each time the touch sensor chip 330 requests, and may be implemented in a form of a look-up table or a matching table.

A resistance value for correcting a resistance component may be recorded in a table, and a coordinate value for correcting an error occurring when determining a coordinate may be recorded in the table.

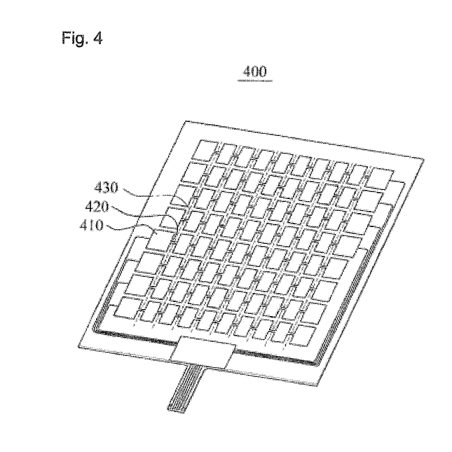

FIG. 4 is a diagram illustrating a first electrode 430 and a second electrode 410 overlapped with each other according to an embodiment of the present invention.

The first electrode 430 and the second electrode 410 described with reference to FIG. 2 and FIG. 3 may be overlapped with each other while maintaining an insulated state.

According to an embodiment, the first electrode 430 and the second electrode 410 may maintain an insulated state in a bridge form, or may maintain an insulated state by being formed on different surfaces of a transparent substrate.

According to an embodiment, at least two electrode surfaces divided by a width size of the second electrode 410 may be included, and the first electrode 430 may be formed at a location corresponding to at least one electrode surface among the at least two electrode surfaces.

According to an embodiment, the second electrode 410 may be formed by electrode patterns including a first electrode surface having a relatively large width and a second electrode surface 420 having a relatively small width.

The first electrode 430 according to an embodiment may be overlapped with the second electrode 410 at a location of the second electrode surface 420 having a relatively small width among electrode surfaces of the second electrode 410.

An electrode surface having a relatively large width between two electrode surfaces of the second electrode 410 according to an embodiment may be formed to have a width larger than a width of an electrode surface of the first electrode 430.

When the first electrode 430 overlaps with the second electrode 410, an overlapped area may become relatively smaller compared with a case of overlapping with the first electrode surface having a relatively large width.

The first electrode 430 and the second electrode 410 according to an embodiment may be formed on one side of a liquid crystal display (LCD) panel. In this instance, the second electrode 410 may be formed to be closer to the LCD panel than the first electrode 430 a distance between the second electrode 410 and the LCD panel may be relatively shorter than a distance between the first electrode 430 and the LCD panel. The first electrode 430 may be formed on a surface closer to a touched object than the second electrode 410.

When the first electrode 430 for a sensing and the second electrode 410 for a driving overlap on a relatively small area, a touch sensitivity may be enhanced compared with a case where an overlapped area is relatively large.

When the overlapped area becomes relatively smaller, an amount of change of a mutual capacitance occurring between the first electrode 430 and the second electrode 410 during a touch may become larger. Further, a signal to noise ratio may be enhanced.

According to the present invention, by enhancing a sensitivity of a mutual capacitance detected by a driving sensing principle, a touch sensitivity may be enhanced.

By decreasing an overlapped area, a transparency of a touch sensing panel may be enhanced.

When an area of overlapped surfaces where the first electrode 430 corresponding to a sensing electrode and the second electrode 410 corresponding to a driving electrode overlap increases, a transparency of the touch sensing panel may deteriorate.

Thus, when a sum of areas with respect to the overlapped surfaces where the first electrode 430 and the second electrode 410 overlap is reduced, a transparency of the touch sensing panel may be enhanced.

Referring to FIG. 4, since an overlapped surface corresponds to a relatively narrow surface of the second electrode 410, a sum of areas of the overlapped surfaces where the first electrode 430 and the second electrode 410 overlap may be significantly reduced. By reducing a sum of areas of the overlapped surfaces, a transparency of the touch sensing panel may be significantly enhanced.

The touch sensing panel according to an embodiment may provide an enhanced touch sensitivity and an enhanced transparency.

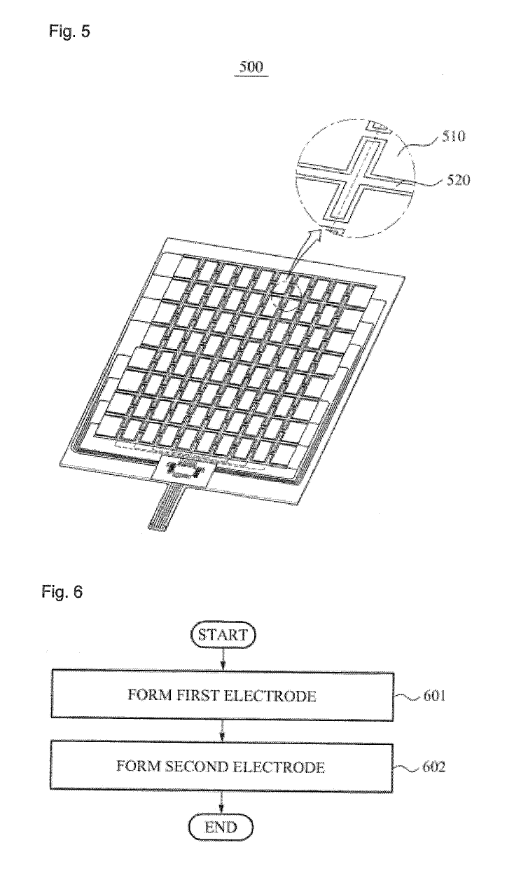

FIG. 5 is a diagram illustrating a plurality of third electrodes 520 and a plurality of second electrodes 510 according to another embodiment of the present invention.

A touch sensing panel 500 according to an embodiment of the present invention may further include the plurality of second electrodes 510 and the plurality of third electrodes 520 disposed between the plurality of second electrodes 510.

Unlike the plurality of second electrodes 510 having a relatively small width at a location corresponding to a first electrode, each of the plurality of third electrodes 520 may have a relatively large width at the corresponding location.

The plurality of second electrodes 510 and the plurality of third electrodes 520 may have forms complementary to each other, and the plurality of second electrodes 510 may have an area relatively larger than an area of the plurality of third electrodes 520.

The plurality of second electrodes 510 may include at least two electrode patterns.

Each of the plurality of third electrodes 520 may have a relatively large width at a location corresponding to the first electrode.

In particular, the plurality of second electrodes 510 according to another embodiment may include a plurality of first electrode patterns, each including the at least two electrode surfaces.

As described above, for convenience of description, the at least two electrode surfaces may be regarded to include an electrode surface having a relatively large width and an electrode surface having a relatively small width.

The plurality of third electrodes 520 may be formed between the plurality of first electrodes 510, and may be electrically insulated from the plurality of second electrodes 510.

A driving signal may be applied to each of the plurality of second electrodes 510, and a mutual capacitance may be formed between the plurality of second electrodes 510 and the plurality of first electrode corresponding to a sensing electrode by a driving sensing principle.

A constant voltage may be applied to the plurality of third electrodes 520 located between the plurality of first electrodes 510. For example, a ground (GND) signal may be applied to the plurality of third electrodes 520.

The plurality of third electrodes 520 according to an embodiment may perform a function of shielding noise occurring from an LCD panel.

The touch sensing panel 500 according to an embodiment may form an additional electrode grounded between driving electrodes at a bottom side to consistently shield noise occurring from the LCD panel.

The touch sensing panel according to an embodiment may be implemented by a touch sensing apparatus.

In particular, the touch sensing apparatus according to an embodiment may include a plurality of first electrodes extending in a first axial direction, a plurality of second electrodes extending in a second axial direction intersecting the first axial direction, and a controller chip to determine a touched input based on a detected signal generated between the plurality of first electrode and the plurality of second electrode.

Here, each of the plurality of second electrodes may have a variable width along the second axial direction, and each width of the plurality of second electrodes may have a minimal value at a point where the second electrode intersects the first electrode.

The touch sensing apparatus according to an embodiment may further include a plurality of third electrodes formed on the same surface as the plurality of second electrodes, and the plurality of third electrodes may be disposed between each of the plurality of second electrodes.

The controller chip according to an embodiment may apply a driving signal to each of the plurality of second electrodes, and may determine the touched input by detecting a change of a mutual capacitance generated between the plurality of first electrodes and the plurality of second electrodes where the driving signal is applied by a touched object.

The controller chip according to an embodiment may apply a driving signal to each of the plurality of second electrodes, and may apply a constant voltage to the plurality of third electrodes. The constant voltage may have a ground level.

FIG. 6 is a flowchart illustrating a manufacturing scheme of a touch sensing panel according to an embodiment of the present invention.

Referring to FIG. 6, in the manufacturing scheme of a touch sensing panel according to an embodiment of the present invention, a first electrode may be formed on a transparent substrate in operation 601, and a second electrode may be formed to be electrically insulated from the first electrode in operation 602.

In this instance, the first electrode may be connected to a touch sensor chip to operate as a sensing electrode in a touch sensing technology of a driving sensing principle. A driving signal may be applied to the second electrode to enable the second electrode to operate as a driving electrode forming a mutual capacitance between the first electrode and the second electrode.

The second electrode according to an embodiment may include at east two electrode surfaces divided by a width size.

The first electrode according to an embodiment may be formed at a location corresponding to one electrode surface among the at least two electrode surfaces.

As a particular example, the second electrode may include two electrode surfaces divided by a width size. In this instance, the first electrode may be formed at a location corresponding to an electrode surface having a relatively narrow width among the at least two electrode surfaces.

When the first electrode is formed at a location corresponding to an electrode surface having a relatively narrow width, a change of a mutual capacitance occurring between the first electrode and the second electrode in response to a touch may significantly increase. Thus, a degree of an amount of change of a mutual capacitance detected in response to a touch may be relatively less influenced by noise. Accordingly, a signal to noise ratio may be enhanced and a touch sensitivity may be enhanced.

Since an area where the first electrode and the second electrode overlap may be reduced, a transparency of the touch sensing panel may be enhanced.

The second electrode according to an embodiment may include a plurality of first electrode patterns, each including the at least two electrode surfaces, and a plurality of third electrodes formed between the plurality of first electrode patterns and electrically insulated from the plurality of first electrode patterns.

In this instance, a driving signal may be applied to the plurality of first electrode patterns, and a constant voltage may be applied to the plurality of third electrodes. In a case where the touch sensing panel is formed on an LCD panel, an influence of decreasing a touch sensitivity due to noise occurring from the LCD panel may be reduced.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A touch sensing panel, comprising: a plurality of first electrodes; and a plurality of second electrodes to which a driving signal is applied, wherein the plurality of first electrodes are electrically insulated from the plurality of second electrodes, and each of the plurality of second electrodes is placed at a location corresponding to the plurality of first electrodes, and has a relatively narrow width.

2. The touch sensing panel of claim 1, further comprising: a plurality of third electrodes disposed between the plurality of second electrodes, wherein each of the plurality of third electrodes is placed at a location corresponding to the plurality of first electrodes, and has a relatively wide width.

3. The touch sensing panel of claim 1, wherein: the plurality of first electrodes are formed in a first axial direction, the plurality of second electrodes are formed in a second axial direction, and the first axial direction intersects the second axial direction.

4. The touch sensing panel of claim 3, wherein points where the plurality of first electrodes intersect with the plurality of second electrodes are disposed in a matrix form on a two dimensional (2D) plane.

5. The touch sensing panel of claim 1, wherein a size of the width corresponds to a scalar value measured in a first axial direction.

6. The touch sensing panel of claim 2, wherein the plurality of second electrodes have a shape meshing with the plurality of third electrodes, and the plurality of second electrodes have a relatively larger area than the plurality of third electrodes.

7. The touch sensing panel of claim 6, wherein a driving signal is applied to each of the plurality of second electrodes, and a constant voltage is applied to each of the plurality of third electrodes.

8. The touch sensing panel of claim 1, wherein the plurality of first electrodes are formed on a surface relatively closer to a touched object than the plurality of second electrodes.

9. The touch sensing panel of claim 1, further comprising: a touch sensor chip to acquire a detected signal generated in the plurality of first electrodes by a touched object, and to generate touch information using the detected signal.

10. The touch sensing panel of claim 9, wherein the touch sensor chip corrects errors of the detected signal due to a resistance component present between two ends of the plurality of first electrodes and the plurality of second electrodes to generate the touch information.

11. A touch sensing apparatus, comprising: a plurality of first electrodes extending in a first axial direction; a plurality of second electrodes extending in a second axial direction intersecting with the first axial direction; and a controller chip to determine a touched input based on a detected signal generated between the plurality of first electrodes and the plurality of second electrodes, wherein each of the plurality of second electrodes has a variable width along the second axial direction, and each width of the plurality of second electrodes has a minimal value at a point where the plurality of second electrodes intersect the plurality of first electrodes.

12. The touch sensing apparatus of claim 11, further comprising: a plurality of third electrodes formed on the same surface as the plurality of second electrodes, wherein the plurality of third electrodes are disposed between each of the plurality of second electrodes.

13. The touch sensing apparatus of claim 11, wherein the controller chip applies a driving signal to each second electrode, and determines the touched input by detecting a change of a mutual capacitance generated between the plurality of first electrodes and the plurality of second electrodes where the driving signal is applied by a touched object.

14. The touch sensing apparatus of claim 12, wherein the controller chip applies a driving signal to each second electrode, and applies a constant voltage to the third electrode.

15. The touch sensing apparatus of claim 14, wherein the controller chip applies the constant voltage at a ground level to the third electrode.

16. A controller chip to determine a touched input applied to the touch sensing panel according claim 1.
